(19) United States
(12) Patent Application Publication
(10) Pub. No.: US 2021/0120779 A1
(43) Pub. Date: Apr. 29, 2021

(54) TENT FOR PETS

(71) Applicant: GUANYI LI, Shenzhen (CN)

(72) Inventor: GUANYI LI, Shenzhen (CN)

(21) Appl. No.: 16/666,028

(22) Filed: Oct. 28, 2019

(51) Int. Cl. A01K 1/03; E04H 15/56; E04H 15/58

(52) U.S. Cl. CPC A01K 1/033; E04H 15/58; E04H 15/56

(57) ABSTRACT

A tent for pets includes two house units. Each house unit includes a floor panel, a front panel, a rear panel, a first side panel, and a second side panel. The front panel includes a front outer flap and a front inner flap. The front outer flap is configured to cover the front inner flap, and is configured to be rolled up or removed. The rear panel includes a rear mesh portion. The first side panel defines a first side opening and includes a first side door removably covering the first side opening. The tent of the present invention is safe, portable and collapsible or foldable for compact storage and shipping.

### FIELD OF THE INVENTION

The present disclosure relates to the field of illumination, and in particular, it relates to a collapsible tent for pets.

### BACKGROUND OF THE INVENTION

Many people have domesticated pets. When traveling, they prefer to travel with their pets rather their leaving their precious pets at home. Many pets suffer separation anxiety when their owner is away. The anxiety can cause the pet to chew on furniture, and generally wreak havoc around the house. When the owner returns, the damage causes the owner unnecessary aggravation and repair expense. A number of portable pet tents are available to pet owners. Pet owners can bring their pets along with them almost anywhere they go. When the owner arrives at his or her destination, he or she sets up the enclosure, indoors or out, and places the pet inside. The pet is safely contained and cannot wander off.

Conventional pet carriers or crates typically are formed of molded plastic. However, conventional plastic carriers do not collapse or break down easily into compact pieces. Such carriers require significant storage space when not in use or when being transported empty. Thus it can be seen that needs exist for improvements to pet housings to provide a portable, collapsible tent for the pets.

### SUMMARY OF THE INVENTION

The technical problem to be solved by the present invention is to provide a tent for pets, which can be collapsed easily into compact pieces.

In order to solve the above technical problem, one embodiment of the invention provides the following technical solution:

One embodiment of the invention provides a tent for pets. A tent for pets includes two house units. Each house unit includes a floor panel, a front panel, a rear panel, a first side panel, and a second side panel. The front panel includes a front outer flap and a front inner flap. The front outer flap is configured to cover the front inner flap, and is configured to be rolled up or removed. The rear panel includes a rear mesh portion. The first side panel defines a first side opening and includes a first side door removably covering the first side opening. The second side panel defines a second side opening and includes a second door removably covering second side opening. A room is defined by the floor panel, the front panel, the rear panel, the first side panel and the second side panel. The two house units comprise a first house unit and a second house unit, the first house unit comprises a first securing portion on the first side panel, the second house unit comprises a second securing portion on the second side panel to couple to the first securing portion, the two rooms are configured to be communicated when the first securing portion and second securing portion are secured and the first side door of the first house unit and the second side door of the second house unit are disassembled.

As a preferred technical solution of the embodiment of the invention, the first side panel and the second panel are arch-shaped.

As a preferred technical solution of the embodiment of the invention, the front panel defines a front opening, and the front inner flap is configured to removably cover the front opening.

As a preferred technical solution of the embodiment of the invention, the front inner flap includes a front mesh portion and a transparent portion and the transparent portion is located below the front mesh portion.

As a preferred technical solution of the embodiment of the invention, the front outer flap is configured to be self-buckled when the front outer flap is rolled up.

As a preferred technical solution of the embodiment of the invention, the rear panel further includes a rear flap covering the rear mesh portion, and the rear flap is configured to be rolled up to uncover the rear mesh portion.

As a preferred technical solution of the embodiment of the invention, the first side door includes a first side flap and a first side mesh portion, and the first side flap removably covers the side mesh portion.

As a preferred technical solution of the embodiment of the invention, the first side door further includes at least one pocket located below the first side flap.

As a preferred technical solution of the embodiment of the invention, each house unit further includes a first seat strap located on a top portion of the rear panel to buckle to an auto seat, and the length of the first seat strap is adjustable.

As a preferred technical solution of the embodiment of the invention, each house unit further includes a second seat strap on the rear panel, and the second seat strap is Y-shaped.

As a preferred technical solution of the embodiment of the invention, each house unit further includes a top panel connecting to the front panel and the rear panel, and a handle is located on the top panel.

In the embodiment above, the tent of the present invention is safe, portable and collapsible or foldable for compact storage and shipping, and is easily assembled by one person without tools or with only minimal tools. The tent of the present invention provides environmental protection for the pet from inclement weather, including precipitation and high winds.

### BRIEF DESCRIPTION OF THE DRAWINGS

The drawings are used for providing further understanding of the present invention, constitute a part of the description and are used for explaining the present invention together with the embodiment of the present invention, but do not constitute a limitation to the present invention. In the drawings:

FIG. 1 is a schematic view of one embodiment of a tent for pets;

FIG. 2 is a schematic view of the embodiment of one house unit of FIG. 1;

FIG. 3 is a schematic view of one embodiment of the house unit of FIG. 2, but shown from another aspect;

FIG. 4 is a schematic view of the embodiment of the house unit of FIG. 3, showing a plurality of supporting rails;

FIG. 5 is a schematic view of the embodiment of the house unit of FIG. 4, but being partially collapsed;

FIG. 6 is similar to FIG. 5, but the house unit is fully collapsed;

FIG. 7 is similar to FIG. 1, but the two house unit is shown from different aspect; and

FIG. 8 is similar to FIG. 1, but the two house units are assembled.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

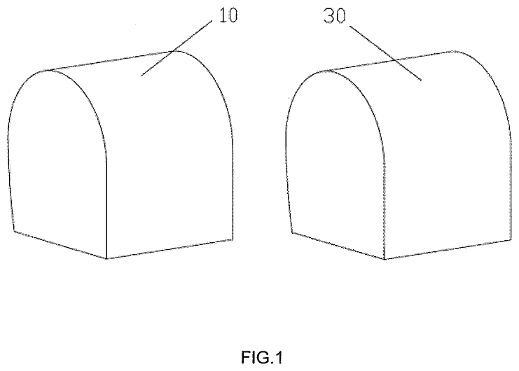

As shown in FIG. 1, in one embodiment, a tent for pets includes a first house unit 10 and a second house unit 30. The two house units have similar the same configuration.

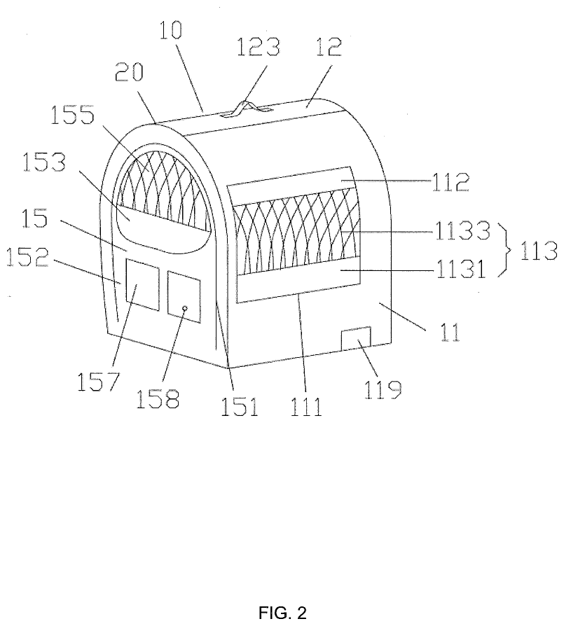

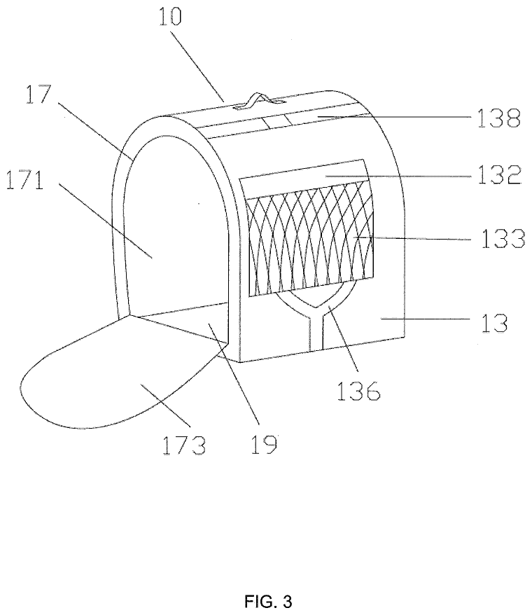

The first house unit 10 preferably includes a plurality of panels, preferably includes a top panel 12; first and second side panels 15, 17; a front panel 11; a rear panel 13; and a floor panel 19, as shown in FIGS. 2-3 securing to a frame 20. When the first house unit 10 is in this assembled or set-up configuration as shown in FIG. 2.

The first and second side panels 15, 17 are upright and generally perpendicular to the generally horizontal floor panel 19. The first and second side panels 15, 17 are generally arc-shaped and generally parallel to one another. The front panel 11 and the rear panel 13 extend from two opposite sides of the floor panel 19. The top panel 12 connects to the front panel 11 and the rear panel 13, and is generally parallel to the floor panel 19. An interior chamber is therefor defined by the floor panel 19, the first and second side panels 15, 17, the front panel 11, the rear panel 13, and the top panel 12 for housing a pet.

The top, bottom, front, rear, and side panels are preferably constructed of a durable flexible fabric such as ballistic nylon or canvas. The floor panel 19 preferably is constructed of a more durable material, such as a metal or hard plastic. Preferably, the floor panel 19 resembles a tray secured to a frame 20.

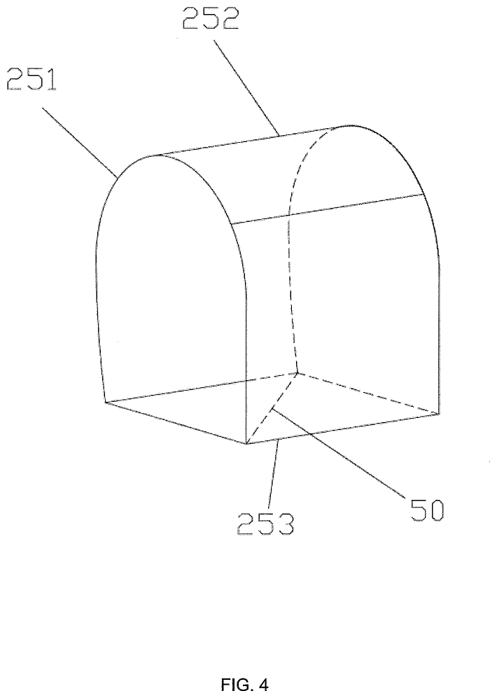

As shown in FIG. 4, the frame 20 preferably includes a plurality of supporting rods 25. The plurality of supporting rods 25 includes two arcuate supporting rods 251. Two arucate supporting rods engage outer edges of the side panels. Two bottom straight supporting rods 253 and two top straight supporting rods 252 support the front panel, rear panel and the top panel.

The front panel 11 defines a front opening 111 for use as a door for pet ingress and egress to/from the interior of the houses unit. The front panel 11 includes a front outer flap 112 and a front inner flap 113. The front inner flap 113 and the front outer flap 112 can removably cover the front opening 111.

The front outer flap 112 is located on an outer side of the front inner flap 113. The front outer flap 112 has a buckle secured to its inner surface near an edge of the front outer flap 112. Thus, the front outer flap 102 can be rolled up and buckled. It should be understood that other types of fasteners, including, for example, snaps, zippers, and buttons, can be employed as well. It should also be understood that the relative position of the fasteners can be moved to other positions along the front outer flap 112. The front outer flap 112 can be zipped to the front panel 11 on two opposite side edges. The front outer flap 112 can be opaque.

The front inner flap 113 includes a front mesh portion 1133 and a transparent portion 1131. The transparent portion 1131 is located below the front mesh portion 1133 adjacent to the floor panel 19. The front inner flap 113 is constructed of a mesh material, secured on the front panel 11 with a zipper such that when the front inner flap 113 is zipped closed; the pet cannot enter or exit the housing 10. A mesh material is used because it permits ventilation to the houses unit, and allows visibility to and from the interior of the house unit.

A card pocket 119 is located on lower portion of the front panel 11 to carry identity information of the pet.

The rear panel 13 includes a rear flap 132 and a rear mesh portion 133. The rear flap 132 removeably covers the rear mesh portion 133. The rear flap 132 may have a buckle secured to its inner surface near an edge of the rear flap 132. Thus, the front outer flap 102 can be rolled up and buckled. It should be understood that other types of fasteners, including, for example, snaps, zippers, and buttons, can be employed as well. It should also be understood that the relative position of the fasteners can be moved to other positions along the rear flap 132. The rear flap 132 can be zipped to the rear panel 13 on two opposite side edges. The rear flap 132 can be opaque.

A first seat strap 138 is located on a top portion of the rear panel 13, and is configured to buckle to an auto seat. The strap length is adjustable. A second seat strap 136 is located on the rear panel 13 below the rear mesh portion 133 to buckle to an auto safety belt. The second seat strap 136 is substantially Y-shaped.

A handle 123 is located on the top panel 12.

The first side panel 15 defines a first side opening 151 and includes a first side door 152 removably covering the first side opening 151. The first side door 152 is substantially arc-shaped. The first side door 152 includes a first side flap 153 and a first side mesh portion 155. The first side flap 153 removably covers the side mesh portion 155. Two pockets 157 are located on a lower portion of the first side flap 153. One of the pockets 157 can be used for carrying ropes, such as bungee cords, for securing the house unit. A through hole 158 is defined in at least one of the two pockets 157 to hold a straw from a water bowl. The pockets 157 can be located on the exterior of the first side panel 15, as depicted, or the pockets 157 can be located on the interior of the first side panel 15.

The second side panel 17 defines a second side opening 171 and includes a second side door 173 removably covers the second side opening 171. The second side door 173 is substantially arc-shaped and can be zipped to the second side panel 17 on an outer edge.

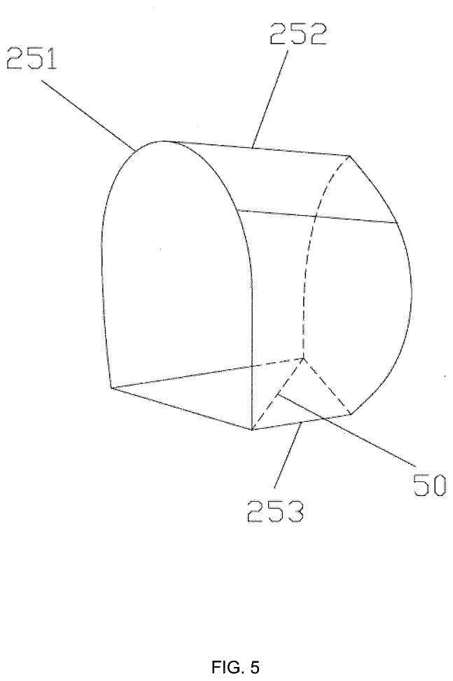

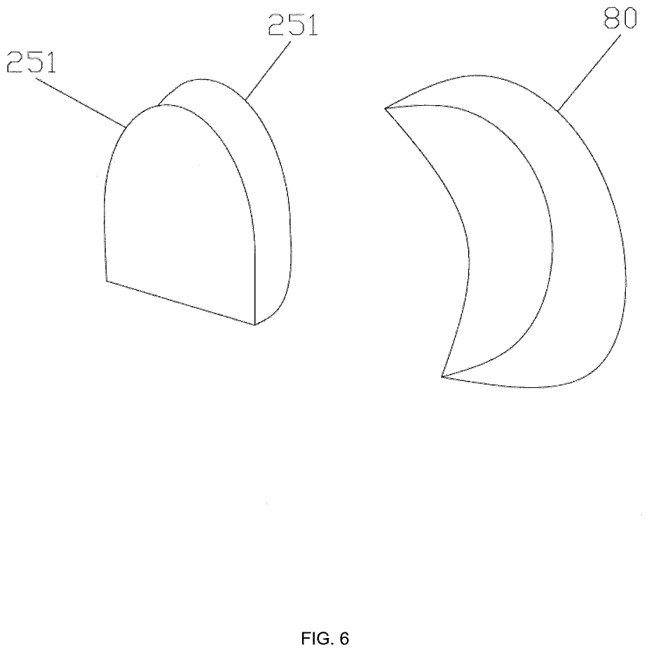

As shown in FIG. 5 and FIG. 6. To collapse the houses unit, the user preferably fold the floor panel 19 along a diagonal line 50 of the floor panel. One side panel may rotate relative to one another one. The two bottom straight supporting rods 253 and two top straight supporting rods 252 are deflected with rotation of the two side panels until the house unit are fully collapsed. When the house unit is collapsed, the two side panels are close together. The room of the house unit is compressed. The collapsed house unit can be stored in a carrying case 80 as shown in FIG. 6.

Each house unit defines a room by the floor panel 19, the front panel 11, the rear panel 13, the top panel 12, the first side panel 15 and the second side panel 17.

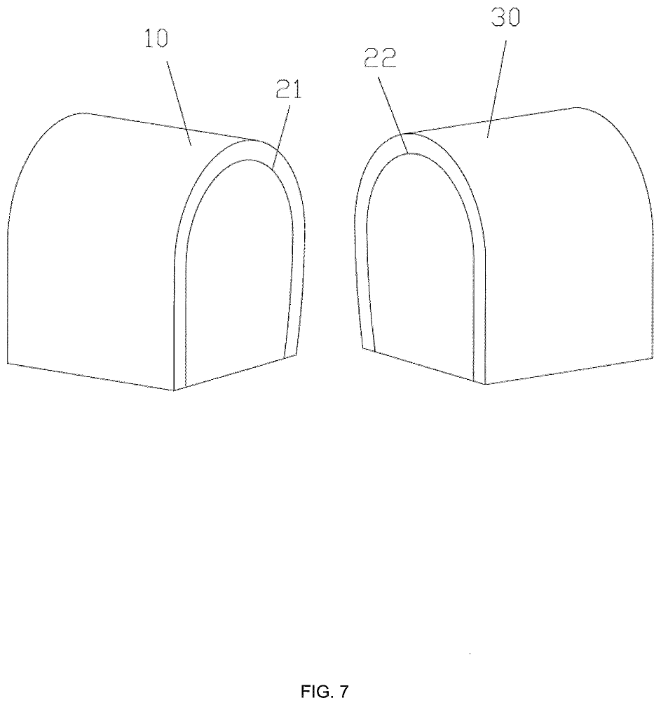

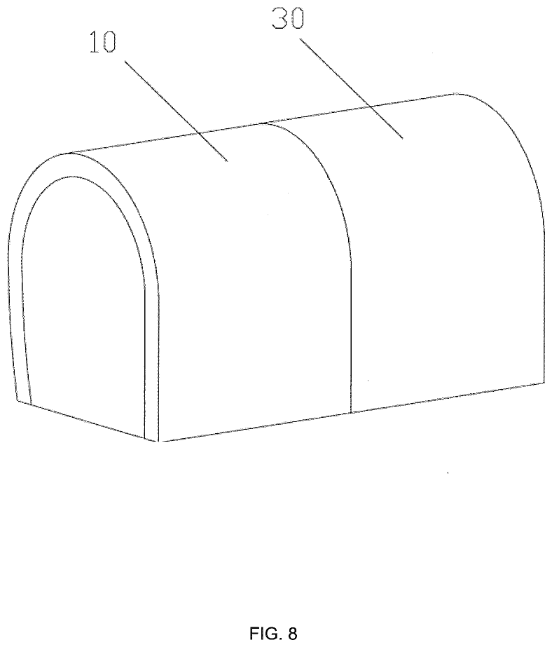

As shown in FIG. 7 and FIG. 8, the first house unit 10 may include a first securing portion 21 on the first side panel. The second house unit 30 may include a second securing portion 22 on the second side panel coupled to the first secured portion 21. The two rooms are configured to be communicated when the first securing portion 21 and second securing portion 22 are coupled, and the first side door of the first house unit 10 and the second side door of the second house unit 30 are uncovered. Thus, the two house units can be assembled to have a large space.

The embodiments shown and described above are only examples. Many details are often found in the art such as the other features of a system for generating picture thumbnail. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A tent for pets, comprising:
two house units, each house unit comprising:
a floor panel;
a front panel, comprising a front outer flap and a front inner flap, the front outer flap configured to cover the front inner flap, and configured to be rolled up or removed;
a rear panel, comprising a rear mesh portion;
a first side panel, defining a first side opening and comprising a first side door removably covering the first side opening; and
a second side panel, defining a second side opening and comprising a second door removably covering second side opening;
a room defined by the floor panel, the front panel, the rear panel, the first side panel and the second side panel;
wherein the two house units comprise a first house unit and a second house unit, the first house unit comprises a first securing portion on the first side panel, the second house unit comprises a second securing portion on the second side panel to couple to the first securing portion, the two rooms are configured to be communicated when the first securing portion and second securing portion are secured and the first side door of the first house unit and the second side door of the second house unit are disassembled.

2. The tent for pets of claim 1, wherein the first side panel and the second panel are arch-shaped.

3. The tent for pets of claim 1, wherein the front panel defines a front opening and the front inner flap is configured to removably cover the front opening.

4. The tent for pets of claim 1, wherein the front inner flap comprises a front mesh portion and a transparent portion and the transparent portion is located below the front mesh portion.

5. The tent for pets of claim 1, wherein the front outer flap is configured to be self-buckled when the front outer flap is rolled up.

6. The tent for pets of claim 1, wherein the rear panel further comprises a rear flap covering the rear mesh portion, and the rear flap is configured to be rolled up to uncover the rear mesh portion.

7. The tent for pets of claim 1, wherein the first side door comprises a first side flap and a first side mesh portion, and the first side flap removably covers the side mesh portion.

8. The tent for pets of claim 7, wherein the first side door further comprises at least one pocket located below the first side flap.

9. The tent for pets of claim 1, wherein each house unit further comprises a first seat strap located on a top portion of the rear panel to buckle to an auto seat, and the length of the first seat strap is adjustable.

10. The tent for pets of claim 9, wherein each house unit further comprises a second seat strap on the rear panel and the second seat strap is Y-shaped.

11. The tent for pets of claim 1, wherein each house unit further comprises a top panel connecting to the front panel and the rear panel, and a handle is located on the top panel.
